(19) United States
(12) Patent Application Publication
(10) Pub. No.: US 2004/0098281 A1
(43) Pub. Date: May 20, 2004

(54) Document processing management system and method

(75) Inventors: Hui-Min Chien, Taipei (TW); Sai-Wing Young, Taipei (TW); Yuh-Huey Tsai, Taipei (TW); J.K. Wei, Taipei (TW)

Correspondence Address: Mr. Peter F. Corless, EDWARDS & ANGELL, LLP, 101 Federal Street, Boston, MA, 02110, US

(73) Assignee: Inventec Corporation

(21) Appl. No.: 10/400,341

(22) Filed: Mar. 26, 2003

(30) Foreign Application Priority Data
Nov. 18, 2002 (TW) 91133605

(51) Int. Cl. G06F 17/60; H04L 9/00

(52) U.S. Cl. 705/1; 713/200

(57) ABSTRACT

A system and a method for document processing management are provided for use in a network environment, for managing part/material documents associated with production fabrication and monitoring approval and verification of the part/material documents to accordingly establish electronic forms of data records. A process flow control module selects predetermined approval and verification procedures used to process the part/material documents and updates a status of document approval and verification. A mail receiving/sending module periodically informs responsible signing departments to perform document approval and verification, and sends mails to other signing departments when document approval and verification is completed. An identity-identifying module identifies and provides a user with appropriate access rights for approval and verification. A document signing/reading module obtains relevant information attached to the approved and verified documents for allowing the user to access the obtained information, and sets the approved and verified documents in a read-only mode.

### FIELD OF THE INVENTION

The present invention relates to document processing management systems and methods, and more particularly, to a management system and method for approval and verification of electronic forms, which can be applied to a network environment such as Internet or Intranet based on client/server architecture to monitor and manage process flow and usage of parts and materials in production processes.

### BACKGROUND OF THE INVENTION

With the transformation of industrial type, the whole enterprise entity gradually become aware of the fact that “staff” and “knowledge/know-how” are crucial elements that affect an enterprise's ability to survive and succeed in the long run. To prepare and accumulate in an early stage the sufficient intelligence capital to be most competitive, no matter what type of industry an enterprise is engaged in, there is required to manage the work flow records and document data when each step enters into an operation process, thereby enable the enterprises to be able to follow up, manage, develop and check the products flow and to reasonably assign human resources to the greatest extent.

However, in conventional enterprises, the company documents are often handed around and delivered by human manipulations, that is, first the written application documents provided by applicants, then there are necessary forms and documents to be filled out and handed over to relevant departments step by step for delivering, examining and signing, and finally the results are passed on to the applicants; each form and document in the delivering process is conducted by manual distribution. Thus the documents in delivering process are often accumulated and delayed by the staff in charge, which may lead to missing deadlines or even loss of data such that the applicant will need to reapply again. This drawback causes not only waste of time and resources, and also complicates the paper work procedures.

Moreover, most work flow forms/documents contain company's work assignments and process flow control information that are important assets, which may even contain business confidentiality in that any form of disclosure is prohibited. Inevitably the protection of business confidentiality is not likely to maintain by using manual delivering of forms/documents as one minor mistake may endanger the company to lose a great deal. Thus to deal with this problem it is necessary to modify conventional means of forwarding company documents by hand delivery.

Further, with the coming and global trend of electronic commerce, the software service suppliers providing application of electronic and network-based services to integrate enterprises resources (Application Service Provider, ASP) have contentiously developed and introduced a variety of documents management application software programs in an effort to replace manpower manipulation and manage the internal important documents and work flow lists in the enterprises for entry into an ideal paperless period. However, the earlier developed documents management systems were designed and made by different software application service providers according to the requirements of different departments (such as accounting department and manufacturing department), making the application system incompatible with each other, this incompatibility between the PC and the other platforms, makes it difficult for users to integrate their older client-server computer systems, thus it is not uncommon that after the executed documents from an A department being forwarded by means of a local area network, LAN to a B department, the executed documents cannot be open and read in computers at B department that obstructs and discontinue document processing within the enterprises.

Therefore, how to seek and provide a document processing management system and method, which can effectively improve manipulation of written paper work in signing and forwarding processes and raise work efficiency for allowing the enterprises to enjoy the convenience and advantages of office automation, is a crucial problem to solve for the application service providers.

### SUMMARY OF THE INVENTION

A primary objective of the present invention is to provide a document processing management system and method to facilitate the process of forwarding the parts/materials confirmation lists to be used for production process and corresponding pre-determined process flow to the executing departments for signing executions, and are capable of performing follow up procedures according to the fixed schedules for tracking specifically the processing of the documents, in order to prevent accumulated backlogs by persons in charge of the cases.

Another objective of the present invention is to provide a document processing management system and method to forward the parts/materials confirmation lists to be used for production process and corresponding pre-determined process flow to the executing departments for signing execution, and further allow the users to retrieve required information of certain parts or materials (such as production specifications, drawings and samples), and enable the department executives to review and evaluate the content before execution.

In accordance with the foregoing and other objectives, the present invention proposes a document processing management system and method for use in the network environment such as the Internet or Intranet, to facilitate signing and checking executions and controlling parts/material confirmation lists used for production process by means of a client/server computer system having powerful functionality, so as to establish enterprise electronic processing and come up with a solution to the foregoing problems. The document processing management system include a plurality of terminal devices and network servers connected to each terminal device, and a service resource system for allowing network servers to exchange information therebetween, by means of a three-tier network-based development environment to forward the parts/materials confirmation lists to preset executing departments for signing and checking executions. Following is the detailed description with reference to the application system and method of document processing management via a network server.

The document processing management system of the present invention comprises a process flow controlling module for automatically selecting signing process according to the content of the document/form, and displaying the latest processing status in each terminal device; a mail receiving/sending module for use to inform periodically and follow up with each responsible department for signing execution, and further send a notice to inform other involved departments after the signing execution is completed; an identity checking module, for identifying the users' identity and assigning the executing limitation according to users' department and authorization; and a documents signing/reading module for use in retrieving the attachments (such as parts sample drawings or product specifications) corresponding to the content of the document from the service resource system therein for department executives' references, and further opening a signing column for users' execution and then setting the executed document into a read-only mode.

The document processing management method of the present invention is applicable to the manufacturing processes of factories, and the documents proposed by corresponding upper-and-down streams departments participated in production processes; upon receiving a request for signing execution of the documents from an applying department, the following steps are proceeded: first, activating a process flow controlling module therein to select a specific signing procedure from the database according to the content and nature of the documents to be executed, and further display said procedure and the latest signing status onto the network server for allowing the involved departments to inspect; next, activating a mail receiving/sending module therein to inform and follow up with each responsible department periodically for signing execution according to said procedure and actual production orders; and activating an identity checking module therein to identify the users' identity and assign limitation of signing according to users' department and authorization; and afterwards activating a documents signing/reading module therein to retrieve and attach the relevant data (such as product specifications or parts lists) corresponding to the documents from the database to said documents for users' references, and then open a signing column for users' execution and after completing execution set the executed documents into a read-only mode, for allowing the users to browse the latest signing status but unable to change it without authorization.

By using the document processing management system for supervising and tracking document processing, the progress of document processing is effectively controlled, so as to prevent backlog accumulation or loss of data relating to parts and sample specifications during the signing procedures; meanwhile the management of electronic data containing different complicated parts drawings and product information by means of electronic attachments enable each relative department to inquire and make reference, allowing the important commercial data to remain intact and securely stored.

### BRIEF DESCRIPTION OF THE DRAWINGS

The present invention can be more fully understood by reading the following detailed description of the preferred embodiments, with reference made to the accompanying drawings wherein:

FIG. 1 is a systemic block diagram showing basic architecture of a document processing management system according to the invention;

FIG. 2 is a flow diagram showing procedural steps for performing a document processing management method according to the invention; and

FIG. 3 is a schematic diagram showing an electronic form to be approved and verified for controlling flow of product parts and materials in the use of the document processing management system according to the invention.

### DETAILED DESCRIPTION OF THE PREFERRED EMBODIMENTS

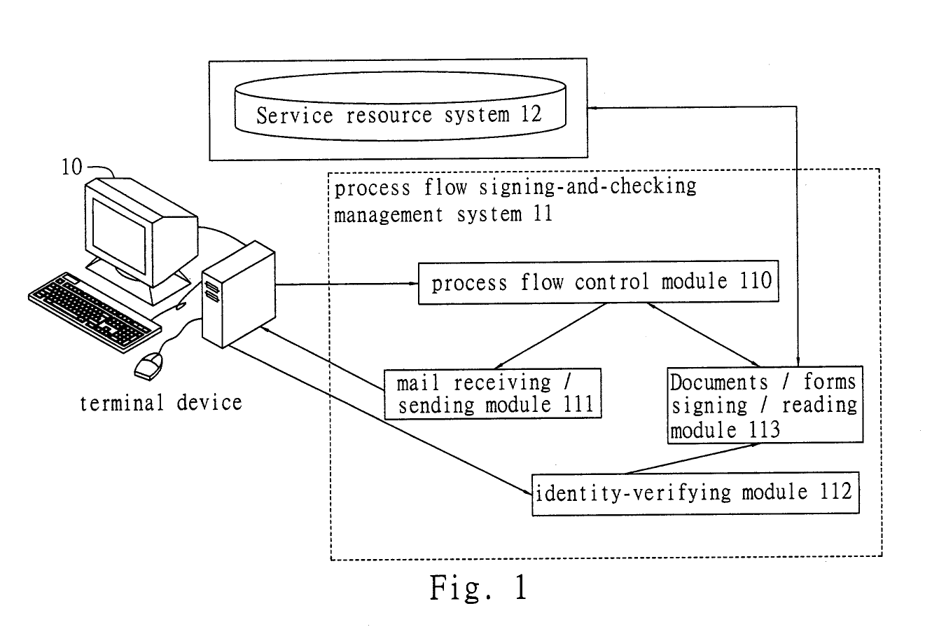

Referring to FIG. 1, it illustrates basic architecture of a document processing management system, as shown in the drawing the document processing management system 11 is constituted under network-based environment such as the Internet or Intranet, for managing the documents to be executed relating to parts and materials used in production processes, which comprises a plurality of terminal devices 10, and a network server for linking each terminal device and is capable of accommodating the system therein, and a service resource system 12 for providing said network server to exchange information therebetween by means of a three-tier network development environment to send the parts/materials documents for signing execution.

The document processing management system 11 comprises a process flow control module 110, for setting the procedural steps of signing and displaying the executed documents on a terminal device; a mail receiving/sending module 111, for informing and tracking departments responsible for timely execution of documents; an identity identifying module 112, for identifying user's identity and opening a signing column according to users' authorization and belonged department; and a documents/forms signing/reading module 113, for retrieving relative data corresponding to the documents and setting the executed column into a read-only mode.

The process flow control module 110 selects automatically the signing procedures according to the content of the documents, and displays the latest signing status of the documents onto each terminal devices. For examples, after the research department obtained a variety of spare parts samples of each type/model and the product specification, it brings up application forms for signing approval based on specific requirements of the products, then the process flow controlling module 110 will select automatically the appropriate signing procedures according to applications of different parts and materials, for deciding the management forms and related documents of the process flow of each spare parts and material.

The mail receiving/sending module 111 informs and periodically following up with each responsible department for timely execution of the application documents. As indicated in this embodiment, after a research department chief completed the signing procedure, the mail receiving/sending module 111 then informs the next involved unit (such as a parts management department) according to actual production and signing procedures, and sends a reply to the research department accordingly, allowing each participated and relative department to be accurately informed of the latest signing status; on the other hand, when the mail receiving/sending module 111 detects delays of a certain department which has not executed in time (such as a parts management department has not signed and executed the documents for over 3 days), it also sends a mail to follow up with the delayed department for expediting execution.

The identity-identifying module 111 is used for identifying users' identity, and authorizing different limits of authority to empower the user to sign the documents according to users' responsible department and levels of authority. As indicated in the embodiment, when a user at a terminal device 10 enters into the process flow management system 11, the identity identifying module 111 therein will request the user to input a staff number and secret code, and accordingly authorize the limit of authority of user and decide to open appropriate columns for signing execution. Taking a quality control department as an example, after a quality control manager enters into the process flow signing management system, the test reports proposed by the quality control inspection department can be seen from the signing document, and at the same time the research department can also enter into said system and inspect the test report from the quality control inspection department, allowing users of different departments to log into the process flow signing management system 11 for inspecting the document whenever needed.

The documents/forms signing/reading module 113 serves to link the signing documents/form by Word document form (Hyperlink) to other service resources system 12, and retrieve relative attachment data corresponding to the content of the documents (such as parts sample drawings or product specification and so on), for providing each participated departments with references and evaluation; moreover, the documents signing/reading module 113 will also set the opening column decided by the identity identifying module 112 into a waiting-for-signing condition, and set the executed columns of the documents and departments into a read-only mode. As shown in this embodiment, the identity identifying module 113 will open different columns for signing executions according to the belonged department (such as research department, quality control department or parts flow management department), thus at the same time the research staff and quality control staff are both able to enter into the network server to inspect the executed documents, but the supervisors of each department can only execute signing within a time limit. When exceeding a time limit or the unauthorized columns will be set into read-only mode and displayed by the process flow control module 110 the latest signing status; the users can login a server any time to browse the latest signing status but cannot change or modify the signing results without authorization.

The process flow signing management system and method of the present invention can punctually supervise and follow up with the documents signing condition to help prevent the responsible staff from accumulating backlog of cases even potential loss of data, also expedite execution of signing actions by means of attachment document to integrate different complex parts drawings and product information into electronic files, which enables the participated departments to cautiously evaluate the operation condition before their signing execution, for allowing product specifications and each important commercial data to be properly managed and stored uniformly.

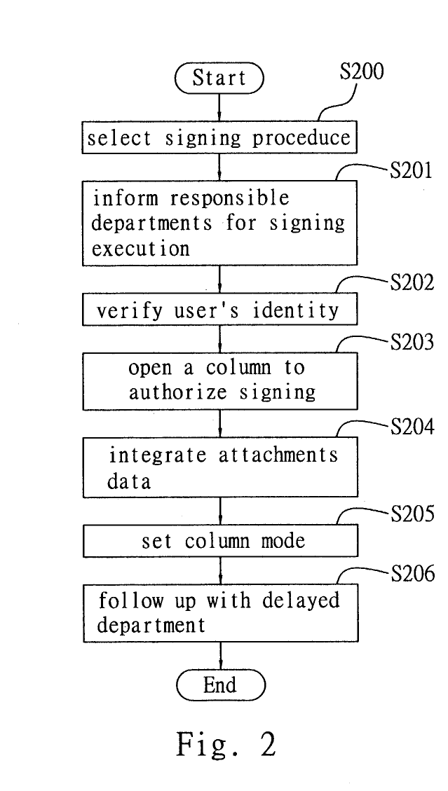

Referring to FIG. 2 which depicts the procedural steps involved in the provision of the process flow signing management system for managing each part/material flow for production use and signing condition in operation, each steps is described with reference to FIG. 1 as follows.

First proceeds to step S200, when the process flow signing management system 11 receives an application from a research department for requesting to use product parts/materials, the process flow control module 10 will select an appropriate signing procedure from a database therein according to the content and applications of the items, and the signing procedures with the latest signing status will be put on network servers via the process flow control module 110 for providing the relative departments to inspect the executed document, then proceeds to step S201.

As shown in step S201, the mail receiving/sending module 111 informs each participated department to execute signing according to the scheduled signing process flow and actual production procedures. Next proceeds to step S202.

As shown in step S202, the identity-identifying module 112 will identify the users' identity and the belonged department according to each user's inputted staff number and secret code displayed on a terminal device when entering into the system. Then proceeds to step S203.

As shown in step S203, the identity-identifying module 112 will open a column to empower the user to sign according to users' belonged department. For example the research department can fill out and execute the relative column designed and opened for research purposes, and also can inspect the signing status of other departments but cannot change and modify data of the columns belonged to other departments. Next proceeds to step S204.

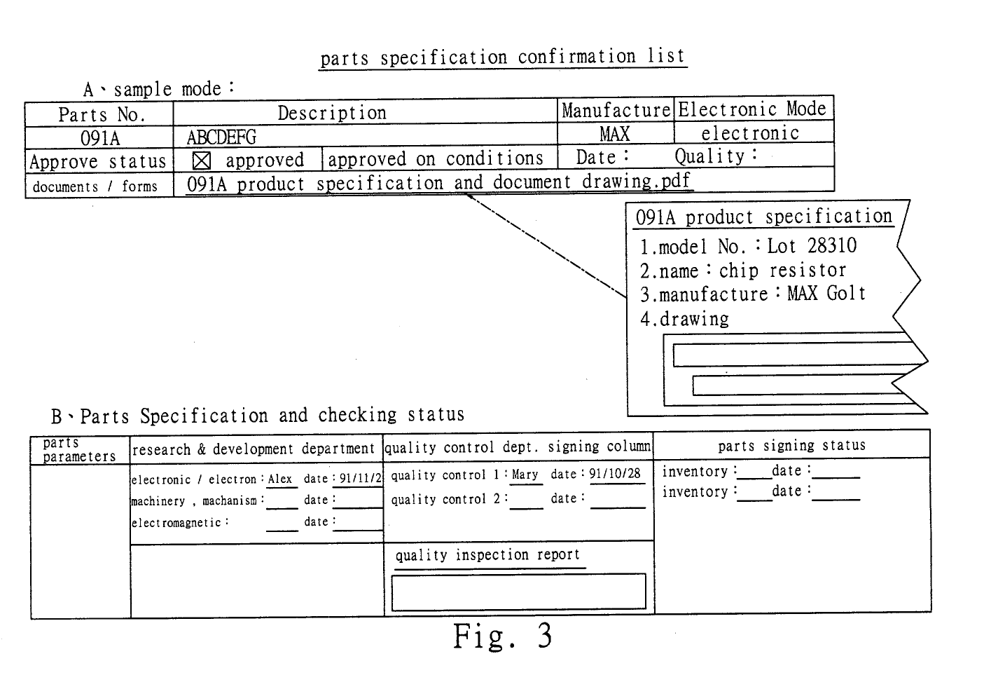

As shown in step S204, the documents signing/reading module 113 retrieves from a service resource system 12 therein the attachment data (such as parts sample drawings or production specifications and so on) corresponding and relating to the content of the document/form to enable the participated departments to inspect and confirm. As shown in FIG. 3, when a research department evaluates and inspects a part/material specification, it clicks a “document” column in the signing document to be hyper-linked to a certain parts production specification and drawing for establishing more complete signing records; and when a quality control department completes the signing procedure, the research department can also check the QA testing report provided by the QA department and the parts application signing status. Then proceeds to step 205.

As shown in step S205, the documents signing/reading module 113 will proceed to set the opened columns according to the identity identifying module 112, after the participated departments complete the signing procedures, the documents signing/reading module 113 then sets the executed documents into a read-only mode, thereby allowing each department to browse online at any time the latest signing status of the document, but not to change or modify the documents without authorization. Then proceeds to step 206.

As shown in step S206, the executing columns in the signing procedures for each participated department execution is set with a time limit for executing, thereby enabling the mailing receiving/sending module 111 to follow up with the delayed department for expediting the signing procedures and assuring timely execution of the documents.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A document processing management system for use in a network environment, for managing part/material documents associated with production fabrication and monitoring approval and verification of the part/material documents to accordingly establish electronic forms of data records, the system comprising:
a process flow control module for selecting predetermined approval and verification procedures used to process the part/material documents according to different part/material applications, and for uploading the latest status of document approval and verification to a network server;
a mail receiving/sending module for periodically informing and reminding responsible signing departments to perform document approval and verification according to the selected approval and verification procedures, and for sending mails to other signing departments when document approval and verification is completed;
an identity checking module for identifying a user and providing the user with appropriate access rights of approval and verification depending on a department of the user; and
a document signing/reading module for obtaining relevant information attached to the approved and verified documents from a service resource system for allowing the user to access the obtained information, and for setting the approved and verified documents in a read-only mode.

2. The document processing management system of claim 1, wherein the document processing management system employs three-tier network architecture including a plurality of terminal devices, the network server connected to the terminal devices, and the service resource system for information exchange with the network server.

3. The document processing management system of claim 1, wherein the mail receiving/sending module sends a mail to a signing department to urge execution of document approval and verification if this signing department fails to perform document approval and verification upon exceeding a predetermined time limit.

4. The document processing management system of claim 1, wherein the identity checking module determines open columns of the approved and verified documents according to the user's access rights.

5. The document processing management system of claim 1, wherein the approved and verified document is of a Word macro format.

6. The document processing management system of claim 1, wherein the attached information is coupled to the approved and verified documents by a hyperlink connection.

7. The document processing management system of claim 1, wherein the attached information is a product specification.

8. The document processing management system of claim 1, wherein the attached information is a part sample drawing.

9. A document processing management method for use in a network environment, for managing part/material documents associated with production fabrication and monitoring approval and verification of the part/material documents to accordingly establish electronic forms of data records, the method comprising the steps of:
having a process flow control module select predetermined approval and verification procedures used to process the part/material documents according to different part/material applications, and upload the latest status of document approval and verification to a network server;
having a mail receiving/sending module periodically inform and remind responsible signing departments to perform document approval and verification according to the selected approval and verification procedures, and send mails to other signing departments when document approval and verification is completed;
having an identity checking module identify a user and provide the user with appropriate access rights of approval and verification depending on a department of the user; and
having a document signing/reading module obtain relevant information attached to the approved and verified documents from a service resource system for allowing the user to access the obtained information, and set the approved and verified documents in a read-only mode.

10. The document processing management method of claim 9, wherein the mail receiving/sending module sends a mail to a signing department to urge execution of document approval and verification if this signing department fails to perform document approval and verification upon exceeding a predetermined time limit.

11. The document processing management method of claim 9, wherein the identity checking module determines open columns of the approved and verified documents according to the user's access rights.

12. The document processing management method of claim 9, wherein the approved and verified document is of a Word macro format.

13. The document processing management method of claim 9, wherein the attached information is coupled to the approved and verified documents by a hyperlink connection.

14. The document processing management method of claim 9, wherein the attached information is a product specification.

15. The document processing management method of claim 9, wherein the attached information is a part sample drawing.
